(19) United States
(12) Patent Application Publication
(10) Pub. No.: US 2014/0163125 A1
(43) Pub. Date: Jun. 12, 2014

(54) WASHABLE POLYURETHANE FOAM AND THE PROCEDURE FOR MAKING IT

(71) Applicants: Nilso Cruccas, Francavilla sul Sinni (IT); Filippo Piccinini, Padova (IT)

(72) Inventors: Nilso Cruccas, Francavilla sul Sinni (IT); Filippo Piccinini, Padova (IT)

(21) Appl. No.: 14/119,137

(22) PCT Filed: May 21, 2012
(86) PCT No.: PCT/IB12/52546

§ 371 Date: Nov. 20, 2013

(30) Foreign Application Priority Data
May 23, 2011 (IT) PD2011A000165

(51) Int. Cl. C08L 75/04

(52) U.S. Cl. CPC C08L 75/04
USPC 521/110; 521/170

(57) ABSTRACT

A washable polyurethane foam has a structure that does not degrade when washed because of being soaked with the washing liquid, or because of treatment with cleaning detergents and/or soap, or because of drying.

### CROSS-REFERENCE TO RELATED APPLICATIONS

This application claims the benefit of PCT Application PCT/IB2012/052546, filed on May 21, 2012, and Italian Patent Application PD2011/A000165, filed on May 23, 2011, both incorporated herein by reference.

### FIELD OF THE INVENTION

The object of this invention is a polyurethane foam that can be washed, and therefore saturated with water and treated with a cleaning detergent and/or soap, and which can easily be dried without undergoing any deterioration of its structure, and which can therefore be reused; therefore the field of application is very extensive: pillows, mattresses, padding material (which can be removed from their covers).

### DISCUSSION OF RELATED ART

As is well known, generally polyurethane cannot be washed. Both rigid polyurethane and flexible polyurethane are materials that we know cannot be washed in the general sense of the word.

Indeed, with reference for example to unforeseen soiling and therefore to the need to clean normal polyurethane foam, this operation can only deal exclusively with the surface part of said polyurethane element, because in-depth cleaning does not work.

Indeed, polyurethane, because of its physical structure, has cells that are quite close together and closed, and this raises the possibility that general dirt, both liquid and fluid, can penetrate deep down into said polyurethane element, even if there is a certain resistance.

Once this dirt has gotten inside the foam it is practically impossible to remove it by washing, because of the difficulty of saturation and the impossibility of saponification with regular detergents, and also because of the removal of the water used for washing with the dirt and soap.

Above all this unfeasibility of drying makes the washing operation practically impossible to carry out, with the consequence of water and/or dampness being retained, to eventually form mold and create bad odors.

In fact, the water, once it has gone down deep into the structure of regular polyurethane, because there are no outlet channels that can take it away directly it remains trapped in the very close-knit mesh of the closed cell structure of the polyurethane, and any centrifugal action leads the force of the water to break the weak walls of the cells, thereby compromising the entire structure of the polyurethane itself.

Even when we look at other systems, like evaporation and/or ventilation, the results are extremely limited and involve just the top layer since the material does not breathe very well.

The drawbacks can easily be understood.

The impossibility of removing unpleasant stains from pillows or mattresses is in itself a well-known shortcoming.

In the context, for example, of healthcare and other similar environments this cannot be tolerated, leading therefore to the complete replacement of the dirty pillow or mattress.

Sometimes, because the pillows or mattresses are made as special elements, with particular and expensive characteristics, their replacement is extremely detrimental, also from an economic point of view.

Currently the only feasible solution is to avoid the polyurethane from getting dirty in the first place, therefore involving the adoption of preventive measures to avoid irreparable damage, while the solution after any involuntary dirtying has happened is basically a banal and pointless palliative like covering the mattress with a cover or the like so that you no idea of what is hidden beneath it.

### SUMMARY OF THE INVENTION

In this situation, the main objective of this invention is to make available a polyurethane foam mattress with characteristics that allow it to be washed.

A further objective of this invention is to make available polyurethane foam that has a physical cell structure that can easily be saturated with washing water, therefore with an open cell structure similar to channels that the water can easily pass through.

A further objective of this invention is to make available polyurethane foam that can be treated with detergents and/or soap, also penetrating deep inside.

A further objective of this invention is to make available polyurethane foam that can also be easily dried after being washed, either by evaporation or ventilation, also deep inside.

A further objective of this invention is to make available polyurethane foam that allows the product to breathe better.

A further objective of this invention is to make available a material for making polyurethane foam articles with a low air flow resistance, and which has considerably improved air permeability characteristics.

A further objective of this invention is to make available a material with high air permeability that is highly resilient for making polyurethane articles.

A further objective of this invention is to make available a composite material for making highly permeable polyurethane articles made of flexible polyurethane with low resilience characteristics, with a slow return in the sector called viscoelastic foams, and which therefore keeps its characteristics in the long term.

A further objective of this invention is to make available a procedure for making polyurethane foam that meets the above-mentioned objectives, and which is completely reliable.

A further objective of this invention is to make available a procedure for making polyurethane foam that is safe.

A further objective of this invention is to make available a procedure for making polyurethane foam that is ecological.

These and other objectives are all attained with the washable polyurethane foam and with the procedure for making the washable polyurethane foam, in line with the attached claims.

### DESCRIPTION OF THE DIAGRAMS

The technical characteristics of the invention, in line with the above-mentioned objectives, can clearly be found in the contents of the claims above and the benefits of it are even more evident in the detailed description that follows, made with reference to the attached diagrams, which depict a form that is purely by way of example and non-binding, where:

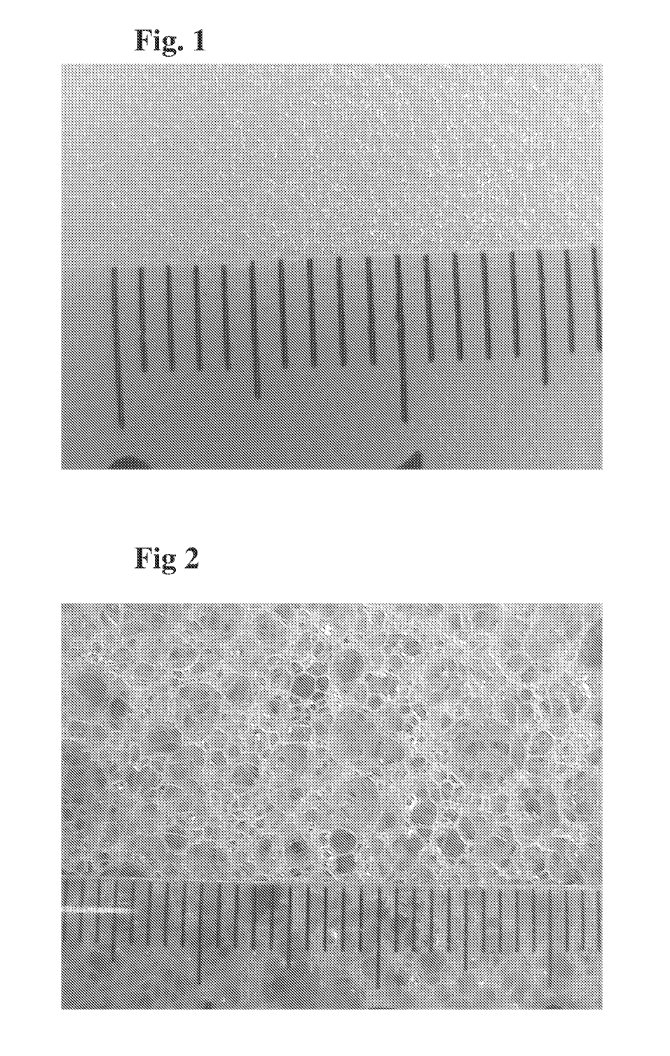

FIG. 1 shows a picture of an enlarged photo of classic polyurethane that highlights the cell structure;

FIG. 2 shows a picture of an enlarged photo of the polyurethane that is the object of the invention that highlights the cell structure;

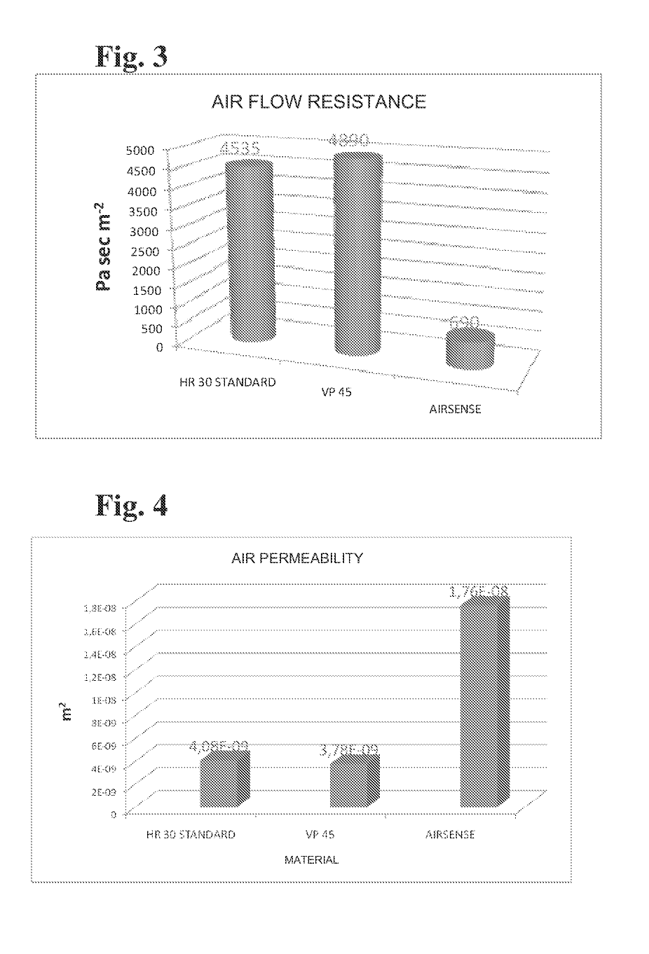

FIG. 3 shows a diagram of the value of the specific air flow resistance of the product that is the object of the invention compared to other polyurethanes on the market; and

FIG. 4 shows a diagram of the air permeability value of the product that is the object of the invention compared to other polyurethanes on the market.

### DETAILED DESCRIPTION

The washable polyurethane foam and the procedure for making it according to this invention are intended to be preferably used for making padding articles, and in particular pillows, mattresses, chairs, or else for making material suitable for being used and inserted as padding, with or without anti-pressure ulcer properties, with a breathable function, for example to be used in bedding, footwear, the car industry, etc.

Moreover, the same composite material and the same procedure can be used in the making of semi-finished products, namely products that can be subjected to further working in order to attain finished decorative items or accessories.

To get a fuller understanding of the characteristics and the benefits of the physical structure of the cells of this washable polyurethane foam product and the procedure for making it, it is necessary to describe how said production process for the washable polyurethane foam is carried out and what is meant by the term washable according to UNI EN ISO 6330 and UNI EN ISO 3175-2 (wet washing and drying).

The procedure, according to the usual way for making polyurethane, comprises the steps of delivering a polyurethane mix to expand on a conveyor or in a production mold using a foaming head.

The chemistry of the polyurethane is based on the reaction of isocyanates with molecules containing active hydrogenates. The —NCO groups contained in the isocyanate molecule react quickly, in the presence of suitable catalysts, with hydrogen atoms bound to more electronegative atoms of carbon.

This reaction leads to the formation of the polymeric structure, with the associated production of carbon dioxide when water is present in the reaction.

Normally, the production of finished polyurethane foam products involves immission into a mold or else, more frequently, a process for producing continuous blocks that are later cut and shaped. From storage tanks, suitably sized and structured for the raw materials and additives that are used, the chemical components are transported using dosing pumps into a mixing room where the raw materials and the additives are weighed and mixed according to a fixed formula. The isocyanate raw material does not take part in the dosing. The isocyanate and the mix obtained in the mix room are sent by means of dosing pumps to the mixing and supply head. The mixing and supply head is part of a foaming line where, in the case of the production of continuous blocks, a conveyor of polyurethane foam is produced, with a prearranged height and cut to the desired length for the production of long blocks of polyurethane. The blocks of polyurethane obtained in this way are stored in tiers where they mature. In the case of mold production, the production line is composed of a series of molds having the shape of the product you want to make, the production sequence is the same, and you put a set amount of product in the mold using the mixing head, the mold is closed, and the polymerization reaction takes place inside, and then later the piece is taken out and stored in tiers for maturation.

The introduction into the production process of additive substances with special mechanical or physical properties is extremely critical. The formulation of the polyurethane, in fact, requires a skilful balance in order to provide a foam product with regular and homogeneous characteristics, and therefore to provide an industrially acceptable product with the desired characteristics. If additives are used these could cause unwanted reactions between the main additive and the raw materials used in the process for producing flexible polyurethane foams, thereby causing instability in the system and a loss of the characteristics of the additive. The flexible polyurethane foam production process can be carried out using molding in specially made molds for single products that already have a form or using continuous foaming, with the production of long blocks to be cut and shaped.

It is generally known in the sector that the above-mentioned additives cannot include anti-foam products since they are contrary to the foaming reaction of the polyurethane.

The object of the invention consists of making a very open cellular structure, similar to channels that can pass water, including water from washing, and which allow the water to run off quickly for drying purposes.

As is well known, a polyurethane structure with large cellulation can be achieved with methods of a physical nature, however channels are not obtained and the results cannot be controlled.

The use of silicone-based additives would tend to create channels but also render the structure with cellulation constant, reducing the size of the cells.

We succeeded in obtaining the desired solution according to the invention with the introduction into the mix (formed of one or more polyoils) of a silicone in a polydimethylsiloxane emulsion.

In particular these results were possible only with the above-mentioned silicone product with the commercial name “Niax foam additive L-853”, used in an unanticipated way, and contrary to expectations.

Since the amount of said silicone needed goes from a minimum of 0.001% in weight of the foam (polyoils, additives, isocyanate) to a maximum of 0.2%, you have to be very careful in evenly dispersing said silicone in the mix, mixing the compound in an adequate way.

Once everything is mixed in a uniform way, the mix is made to react with the isocyanate using the method described above.

With the procedure set out above you obtain a washable polyurethane foam product that has a high degree of open cell structure that allows water to easily pass between the cells, and which can wash deep down.

This open cell structure also considerably facilitates drying.

Indeed, without the necessary open cell structure it would not be possible to wash, including repeated washes of the industrial variety, using not only water but also detergents.

From a simple comparison of the photos in FIG. 1 and FIG. 2 that show the cell structure of classic polyurethane, with a scale in mm, compared to the cell structure of the polyurethane that is the object of the invention, in FIG. 2 the considerable cellular openness of various orders of size of the polyurethane of the invention is evident, which makes possible all the advantages mentioned above regarding the possibility of washing and drying and those below regarding breathability.

Surprisingly, with the above-mentioned open cell structure you also get cellulation that provides the polyurethane with breathability.

The product that is the object of this invention has been shown to have a resistance between 300 Pa sec m-2 and a maximum of 1000 Pa sec m-2 (measurements carried out in accordance with UNI EN ISO 4638).

Therefore in accordance with a preferred form of the washable flexible polyurethane foam that is the object of this invention, the air permeability measured with a laboratory analysis in conformity with UNI EN ISO 4638 confirmed the expected result.

In order to fully evaluate the importance of the invention, the air permeability has to be compared to the usual one of the most common polyurethanes.

From some tests carried out in specialized laboratories it was confirmed that the innovative lift of the invention, as is evident from FIGS. 3 and 4 regarding the measurement of the air permeability of the object of the invention compared to standard polyurethane.

The first sample of standard polyurethane for comparison is a polyurethane foam called a highly resilient block with a density of 30 kg/m³; it is a product that is widely used and it is the product that is the most manufactured and consumed; it is produced in a continuous process on a conveyor; the reaction takes place on the conveyor belt; it is a product that is generally sold in cubes with sizes of about 1 meter by 2 meters by 2; this product is used for the production of mattresses, pillows, chairs, furniture, armchairs, sofas, etc. . . . and called in the fact sheet 30 HR STANDARD.

The second polyurethane sample is viscoelastic polyurethane foam, i.e. high energy, slow return foam. The density of this product is 45 kg/m³, and is called VP 45.

The third polyurethane sample made in accordance with the procedure of the invention is slow return, high energy absorption viscoelastic polyurethane foam with a density of 45 kg/m³. It is called AIRSENSE AS 45.

The table below has the air breathability and air flow resistance results of the three types of polyurethane mentioned above. The tests were carried out in accordance with UNI EN ISO 4638.

The values shown in the table are average values, and as per legislation they are the averages of 5 tests for each material.

| | AIR FLOW | AIR |
|---|---|---|
| | RESISTANCE | PERMEABILITY |
| | UNIT OF | UNIT OF |
| | MEASUREMENT | MEASUREMENT |
| MATERIAL | Pa sec m⁻² | m² |
| 30 HR STANDARD | 4535 | 4.08 × 10⁻⁹ |
| VP 45 | 4890 | 3.78 × 10⁻⁹ |
| AIRSENSE AS | 690 | 1.76 × 10⁻⁸ |

It is clear from the attached diagrams FIGS. 3 and 4, regarding the transfer to a chart form of the above-mentioned values, that the air flow is about 1/7 of the usual typical values of standard polyurethane.

With some samples of the new polyurethane foam that is the object of the invention a specific air flow resistance of 1/10 of the value of standard polyurethane was confirmed. From the chart regarding air permeability, the soundness of the invention can be seen, which some samples have confirmed to be much better than standard polyurethane.

An example of a preferred realization of the above-mentioned product AIRSENSE AS 45 provides for the preliminary realization of a master batch.

This master batch is composed of the combination of a mixture of polyoils, plus any other additives (generally indicated as SP3 mix) and of said additive NIAX L-853 in a ratio of 50 gr of NIAX L-853 per Kg of SP3 mix.

Because of the enormous percentage difference of the compounds, the master batch is obtained from a mixing that can take a long time in order to be sure of having an even dilution of the NIAX L-853 additive.

Only after having prepared this master batch can you proceed with making the base mix, about which the amounts for preparing two examples of a preferred realization are provided below:

AIRSENSE AS 45 SOFT and AIRSENSE AS 45 N, which differ from one another because of a different structural resistance.

The SP3 mix is combined with a polyester polyoil called IMUCURE GRS 110-500 in a ratio of 78.7 Kg of SP3 mix to 21.3 Kg of IMUCURE GRS 110-500.

To these compounds are added also 500 gr of master batch mix to attain the base mix to be used to make AIRSENSE AS 45 SOFT (which has an isocyanate/mix ratio of 0.54).

While to these compounds are added also 270 gr of master batch mix to attain the base mix to be used to make AIRSENSE AS 45 N (which has an isocyanate/mix ratio of 0.64).

Below is a table with the amounts of the components for making two commercial products AIRSENSE AS 45 SOFT and AIRSENSE AS 45N.

| | AS 45 SOFT | AS 45 N |
|---|---|---|
| BLOCK 200*158*50 | R = 54 | R = 64 |
| SP3 | 35.4 KG | |
| IMUCURE | 9.6 KG | |
| isocyanate | 25.2 KG | 28.8 KG |
| MASTERBATCH | 200-220 GR in 750 gr SP3 | 100-120 in 750 gr SP3 |

Another example with dimensions of the end product that are different from those in the table above is shown below.

| | AS 45 SOFT | | AS 45 N |
|---|---|---|---|
| BLOCK 209*168*50 | R = 54 | | R = 64 |
| SP3 | 37.7 | KG | |
| IMUCURE | 10.2 | KG | |
| SWL | 27. | KG | 30.8 KG |

| | | |
|---|---|---|
| MASTERBATCH | 210-230 GR in | 110-140 GR in |
| | 750 gr SP3 | 750 gr SP3 |

1. A washable polyurethane foam including:
a composite component composed of polyoils and eventual additives, at least one of said additives being a silicone in a polydimethylsiloxane emulsion with a percentage of between 0.0001% in weight of the foam to a maximum of 0.2%; and
an isocyanate component.

2. The washable polyurethane foam according to claim 1 wherein the silicone is a silicone with the commercial name of “Niax foam additive L-853.”

3. The washable polyurethane foam according to claim 1 having a relatively high percentage of open cells and being washable in accordance with UNI EN ISO 6330 and/or UNI EN ISO 3175-2.

4. The washable polyurethane foam according to claim 1 wherein the foam can easily be saturated with washing water.

5. The washable polyurethane foam according to claim 1 wherein the foam can be washed with detergents without any noticeable deterioration of the structure of the foam.

6. The washable polyurethane foam according to claim 1 wherein the foam dries even after washing, either by evaporation or deep aeration.

7. The washable polyurethane foam according to claim 1 wherein air can pass through the foam with a degree of air resistance between 300 Pa sec m-2 and about 1000 Pa sec m-2, measured in accordance with UNI EN ISO 4638.

8. A procedure for making a washable polyurethane foam including the steps of:
preparing a composite component composed of polyoils and eventual additives, at least one of said additives being a silicone in a polydimethylsiloxane emulsion with a percentage of between 0.0001% in weight of the foam to a maximum of 0.2%;
mixing said composite component with said silicone in a polydimethylsiloxane emulsion in order to obtain an even mixture;
preparing an isocyanate component;
mixing said composite component having said silicone in a polydimethylsiloxane emulsion with said isocyanate component;
delivering the above-mentioned mixture inside a mold; polymerizing said mixture until the product obtained from the polymerization of said mixture does not deform under its own weight; and
extracting the resulting product from said mold.

9. The procedure for making a washable polyurethane foam according to claim 8 wherein the silicone is a silicone with the commercial name of “Niax foam additive L-853.”

10. The procedure for making a washable polyurethane foam according to claim 8 wherein a master batch is made of 50 gr of silicone per kg. of mix of polyoils plus various additives, suitable for being inserted in a ratio of between about 270 to 500 gr per 100 kg of base mix product.

11. A procedure for making a washable polyurethane foam including the steps of:
preparing a composite component composed of polyoils and eventual additives, at least one of said additives being a silicone in a polydimethylsiloxane emulsion with a percentage of between 0.0001% in weight of the foam to a maximum of 0.2%;
mixing said composite component with said silicone in a polydimethylsiloxane emulsion in order to obtain an even mixture;
preparing an isocyanate component;
mixing said composite component having said silicone in a polydimethylsiloxane emulsion with said isocyanate component;
delivering the above-mentioned mixture on a foaming line into blocks;
polymerizing said mixture until the product obtained from the polymerization of said mixture does not deform under its own weight; and
cutting the blocks obtained from the foaming line.

12. The procedure for making a washable polyurethane foam according to claim 11 wherein the silicone is a silicone with the commercial name of “Niax foam additive L-853.”

13. The procedure for making a washable polyurethane foam according to claim 11 wherein a master batch is made of 50 gr of silicone per kg. of mix of polyoils plus various additives, suitable for being inserted in a ratio of between about 270 to 500 gr per 100 kg of base mix product.
